(19) United States
(12) Patent Application Publication
(10) Pub. No.: US 2004/0266442 A1
(43) Pub. Date: Dec. 30, 2004

(54) Method and system for optimising the performance of a network

(76) Inventors: Adrian Flanagan, Helsinki (FI); Tomas Novosad, Helsinki (FI); Jaana Laiho, Veikkola (FI); Albert Hoglund, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/493,633

(22) PCT Filed: May 31, 2002
(86) PCT No.: PCT/IB02/01962

(30) Foreign Application Priority Data
Oct. 25, 2001 (WO) PCT/EP01/12374

(51) Int. Cl. H04Q 7/20

(52) U.S. Cl. 455/445; 455/450

(57) ABSTRACT

When optimising the performance of the network, first of all, the relevant key performance indicators for a specific entity within the network as well as first parameters, which influence the key performance indicators, are determined. A number of entities similar to said specific entity is selected, wherein relevant key performance indicators are associated to every entity. The key performance indicators as well as the selected number of entities are used as elements in a first cost function, i.e. said first cost function is calculated on the basis of the KPI and the number of entities. Said first cost function is calculated in order to evaluate the network performance. Accordingly, since said first parameters directly relate to the key performance indicators, the network performance will depend on the values of said first parameters.

Thereafter the values of said first parameters are adjusted, so that a second set of values of said first parameters are obtained. The key performance indicators are determined again but this time on the basis of the second values of said first parameters and said first cost function is recalculated on the basis of these key performance indicators. The result of said first cost function calculated on the basis of said first values of said first parameters is compared to the result of said first cost function recalculated on the basis of said second values of said first parameters. This comparison is carried out to determine whether the network performance has improved. When the network performance has improved due to the adjusting of said first parameters, said second values of said first parameters are adopted as permanent parameters.

### FIELD OF THE INVENTION

The invention relates to a method and system for optimising the performance of a network.

### BACKGROUND OF THE INVENTION

Telecommunications Management Network (TMN) model provides a widely accepted view about how the business of a service provider is to be managed. The TMN model consists of four layers, usually arranged in a triangle or pyramid, with business management at the top, service management the second layer, network management the third layer, and element management at the bottom. Management decisions at each layer are different but related to each other. Working from the top down, each layer imposes requirements on the layer below. Working from the bottom up, each layer provides important source of data to the layer above. The TeleManagement Forum's (TMF) TMN sets the guidelines for the optimisation functionalities and processes. The 3^{rd} Generation Partnership Project (3GPP) has adopted the same model. The scope of TMF is to find standardised way to define service quality, set requirements for networks in terms of quality of service (QoS) measurements, and make it possible to have QoS reports between providers and systems that implement the service.

According to the TMN model the information from the upper level systems flows down, guaranteeing seamless operation and optimisation possibilities for the network. The TMN model is depicted in FIG. 3. The information flow from the business management layers all the way down to the service management and network management layers is essential since the business aspects have to be considered carefully in the optimisation and network development process. The TMN model demonstrates the change of the abstraction level in the operator's daily work. The business plan efficiency can be measured with capital and operational expenditure (CAPEX, OPEX) and revenue. The wanted business scenario is then translated to offered services, service priorities and service QoS requirements. On the lowest (network element) level of the TMN model the business related issues are converted into configuration parameter settings.

Functions supported by TMN's Business Management Systems are, for example, to create an investment plan, to define the main QoS criteria for the proposed network and its services, to create a technical development path (expansion plan) to ensure that the anticipated growth in subscriber numbers is provided for.

Functions supported by Service Management Systems are for example to take care of subscriber data, the provision of services and subscribers, to collect and rate bill offered services, to create, promote and monitor services.

Functions supported by Network Management Systems (NMS) are to plan the network, to collect information from the underlying networks and pre/post-process the raw data, to analyse and distribute information, to optimise network capacity and quality.

Element management systems can be considered as part of Network Element functionality with the responsibility to monitor the functioning of the equipment, to collect raw data (performance indicators), provide local graphical user interface (GUI) for site engineers, and to mediate towards the NMS system.

In addition to TMN, the TMF also defines a Telecom Operations Map (TOM). Telecom and data service providers must apply a customer oriented service management approach using business process management methodologies to cost effectively manage their businesses and deliver the service and quality customers require. TOM identifies a number of operations management processes covering Customer Care, Service Management and Network Management. The Telecom Operations Map uses the layers of the TMN model as core business processes, but divides the service management layer into 2 parts: Customer Care and Service Development and Operations. Customer Interface Management is separately delineated, because Customer Interface Management may be managed within the individual Customer Care sub-process or, in combination across one or more of the Customer Care sub-processes.

FIG. 4 shows the high-level structure of Network Management processes and the supporting Function Set Groups. According to the framework provided by TOM it is possible to map each of the high level processes to a series of component functions (arranged in function set groups). Provided that:

Network performance management (PM) provides adequate measurements;

Network configuration management supports the whole TMF frame work;

There is intelligence in network management system (NMS) to combine these two information.

It then identifies relationships and information flows between them. In FIG. 4 the TOM and its components are presented. The functionalities of the layers are the same as in FIG. 3 to indicate the corresponding management layers.

A detailed description of the TMN model and the TOM can be found on the homepage of the TMF (see http://www.tmforum.org).

In current cellular systems the radio resources are handled with numerous parameters, wherein the parameter value settings are fixed even in changing conditions. The task of an operator is to manually tune the parameter settings to meet the right operating point in terms of quality of service. Often the objective when doing optimising has been “just to get it working”. This tuning has been relatively straightforward in simple GSM networks with pure speech services. In the case of WCDMA the complexity of these parameter settings is manifold: multiple services, service classes, even multi-radio environment. The WCDMA based cellular systems will offer variability of packet and circuit switched services and therefore are more complicated to plan and control than today's networks. The strong coupling of the cells adds the complexity. For an operator it is essential to utilise all possible resources to improve the capacity and Quality of Service (QoS) of the radio network.

A network optimising process serves to improve the overall network quality as experienced by the mobile subscriber and to ensure an efficient use of the network resources. The optimising process includes the analysis of the network and improvements in the network configuration and performance. Statistics of key performance indicators (KPI) for the operational network are fed to a tool for analysing the network status and the radio resource management (RRM) parameters can be manually tuned for the better performance. The key performance indicators (KPI) are defined in an initial phase of the optimisation process. They consist for example of measurements in the network management system (NMS) and of field measurement data or any other information, which can be used to determine the quality of service (QoS) of the network. For a second generation systems quality of service QoS has consisted for example of dropped call statistics, dropped call cause analysis, handover statistics and measurements of successful call attempts, while for third generation systems with a greater variety of services new definitions of quality of service QoS for quality analysis must be generated.

To optimise the overall revenue of a network operator or a service provider reducing the costs of the operation and maintenance of a network system has prompted the need for process automation in said network system.

### SUMMARY OF THE INVENTION

It is therefore an object of the invention to improve the process of optimising network resources.

This object is solved by a method for optimising the performance of a network according to claim 1, a corresponding system according to claim 14.

The invention is based on the idea to optimise network resources by means of one centralised cost function rather than optimising the network resources separately.

Currently the radio resource management algorithms are parameterised separately: handover control, admission control, power control etc. parameter values are set independently and one can identify cases where for example hand over problems are due to wrong power control (CPICH) setting. Change in the admission control setting can result in a change in the quality of the packet data.

Therefore, when optimising the performance of the network, first of all, the relevant key performance indicators for a specific entity within the network as well as first parameters, which influence the key performance indicators, are determined. A number of entities similar to said specific entity is selected, wherein relevant key performance indicators are associated to every entity. The key performance indicators as well as the selected number of entities are used as elements in a first cost function, i.e. said first cost function is calculated on the basis of the KPI and the number of entities. Said first cost function is calculated in order to evaluate the network performance. Accordingly, since said first parameters directly relate to the key performance indicators, the network performance will be depend on first values of said first parameters.

Thereafter the values of said first parameters are adjusted, so that a second set of values of said first parameters are obtained. The key performance indicators are determined again but this time on the basis of the second values of said first parameters and said first cost function is recalculated on the basis of these key performance indicators. The result of said first cost function calculated on the basis of said first values of said first parameters is compared to the result of said first cost function recalculated on the basis of said second values of said first parameters. This comparison is carried out to determine whether the network performance has improved. When the network performance has improved due to the adjusting of said first parameters, said second values of said first parameters are adopted as permanent parameters.

Setting separate parameters based on many algorithms rather than optimising a parameter set with a central control function can cause oscillations in the parameter values, since cases may occur where changing one parameter to optimise a KPI may adversely affect other KPI's. Therefore, it is advantageous to monitor the radio resource management as a whole by a centralised cost function rather than individual functions, in order to coordinate the changing of the respective parameters.

According to a development of the invention, the respective key performance indicators are weighted with different weight coefficients within said first cost function. Using different weight coefficients allows to allocate more influence of one or more key performance indicators on the first cost function.

According to a further development of the invention, reference values for the key performance indicators are set and the key performance indicators in the first cost function are replaced by the difference between the current key performance indicators and the respective reference values (to define the “cost” see equation (1)). Hence, the first cost function is now calculated on the basis of the difference between the current key performance indicators and the respective reference of values. This allows to set quality of service targets based on the cost of the KPI(s).on the system.

According to a preferred development of the invention, said first cost function is composed of a second and a third cost function, wherein said second cost function represents the quality requirements within the network and said third cost function represents the capacity requirements within the network. Said second cost function is weighted with a second weight coefficient while said third cost function is weighted with a third weight coefficient. Providing the second and third cost function in connection with their respective weight coefficients makes it possible to incorporate the trade-off between capacity and quality within the first cost function.

According to a further preferred development of the invention, the second and third cost function are composed of the selected entities, wherein the determined key performance indicators are associated to each entity. This allows to incorporate a broad distribution of key performance indicators from across the network.

According to a further development of the invention, said entity can be represented by the cell or the user group within the network. Accordingly, the cost function can be calculated for example on the basis of a cell or a cluster of cells.

According to a further preferred development of the invention, the steps for optimising the network performance are iterated, so that the optimising process can be automated.

According to still a further preferred development of the invention, the values of the KPI's together with the respective first parameters and the corresponding result of the first cost function are stored to create a history database. The current result of said first cost function is compared with previous results thereof stored in the history database in order to determine whether the network performance has improved within a predetermined time interval. However, if no improvements of the network performance have been made within said predetermined time interval a respective notification is being issued. Issuing the notification when no improvements are detected for a predetermined time interval, can avoid the occurrence of deadlock during the automated process and point out to possible problems.

### BRIEF DESCRIPTION OF THE DRAWINGS

In the following, the present invention will be described in greater detail on the basis of preferred embodiments with reference to the accompanying drawings, in which:

FIG. 1 shows a flow chart of an automated process for optimising the network performance

FIG. 2 shows an example of a KPI cost function;

FIG. 3 shows a diagram of the telecommunications management network (TMN) model;

FIG. 4 shows a diagram of the Telecom operation map (TOM), and

FIG. 5 shows an illustration of the combination of monitoring and optimising functions to combine different management layers.

### DESCRIPTION OF THE PREFERRED EMBODIMENT

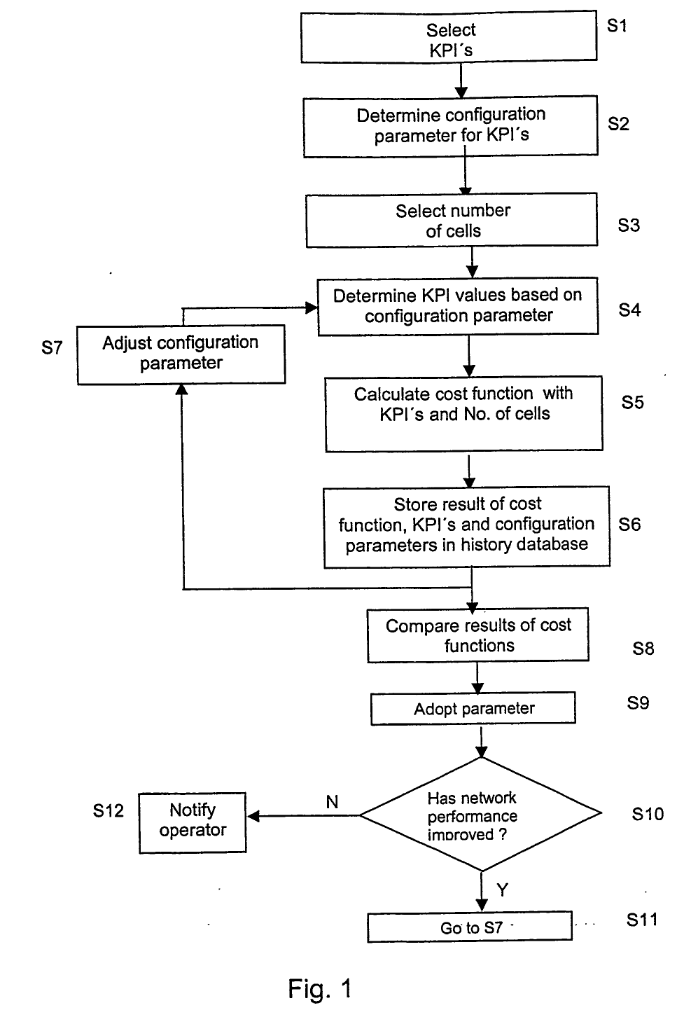

In FIG. 1 a flow chart of an automated process for optimising the network performance according to the first embodiment is shown. First of all, in the step S1, those key performance indicators, which describe the performance of the part of interest of the network, are selected. Then, in step S2 those configuration parameters, upon which the KPI's depend on, are determined. In step S3 the number of cells, which are to be included into the optimising process, are selected, i.e. selecting a cluster of cells. The current values of the KPI's are determined based on the respective configuration parameters in step S4. Thereafter, in step S5 the cost function is calculated on the basis of the current values of the KPI's and the number of cells. The result of the cost function, the values of the KPI's and the configuration parameters are stored in a history database in step S6.

At least one value of the respective configuration parameters is adjusted in step S7, resulting in a new set of configuration parameters. Based on this new set of configuration parameters new KPI values are determined in step S4 and the cost function is re-calculated in step S5 on the basis of the new KPI values and the (unchanged) number of cells as selected in step S3. The new result of the cost function, the new KPI and configuration parameter values are also stored in the history database in step S6. Subsequently, the new result of the cost function—based on the new/adjusted set of configuration parameters—is compared to previous results of the cost function stored in the history database in step S8 in order to determine whether the network performance of interest has improved after adjusting the configuration parameters.

If the network performance has improved after adjusting the configuration parameters, the adjusted set of configuration parameters are adopted as permanent parameters in step S9. While, if it has been determined in step S8 that the network performance has not improved after adjusting the configuration parameters, the first set of configuration parameters, as stored in the history database in step S6, are adopted as permanent parameters in step S9.

In step S10 is checked whether the network performance has improved within a predetermined time interval. When the network performance has not improved during the predetermined time interval, i.e. the KPI history has not improved even though auto-tuning is performed, the network operator is notified in step S12 that a problem has occurred with the automated process for optimising the network performance. Since it is clear that many of the parameter values will not be auto-tuned, and that autotuning cannot always optimise the network, the operator can then check whether this problem is due to hardware problems or whether—under the current network conditions—it is not possible to automatically optimise the network performance. In such a case of the network operator will have to resume to manually optimise the network performance.

On the other side when the network performance has improved during the predetermined time interval the flow jumps to step S7 where the configuration parameters are adjusted again in order to further optimise the network performance. The flow will then continue as described above.

In a second embodiment not only the relevant KPI's are selected in step S1 but also a set of QoS targets is determined, which is expressed in a set of reference KPI. The automated process for optimising the network performance according to the second embodiment corresponds substantially to the optimising process according to the first embodiment. The only difference is that the difference between the KPI and the reference KPI is used instead of the KPI value when the calculating the cost function in step S5.

Accordingly, the operator sets capacity requirements for certain capacity KPIs denoted KPI_C with “ref” in the sub-index. Correspondingly, the operator sets quality requirements for certain KPI_Qs. The quality and capacity costs can then be calculated as in equation (1).

$$QualityCost = {\sum }_{cells ∈ CLUSTER} {\sum }_{i} {α}_{i} * f ( {KPI\_Q}_{i} - {KPI\_Q}_{i , ref} ) \\ CapacityCost = {\sum }_{cells ∈ CLUSTER} {\sum }_{i} {β}_{i} * f ( {KPI\_C}_{i} - {KPI\_C}_{i , ref} ) \qquad ( 1 )$$

Different cost functions can be combined or summed with weight coefficients α and β. By controlling or changing weight coefficients α and β a certain type of cost can be emphasised and the overall some.

The mathematical formulation of the task of optimising the network performance can be seen as to find a combination of air interface configuration parameters based on which the KPIs are as close to the desired area as possible.

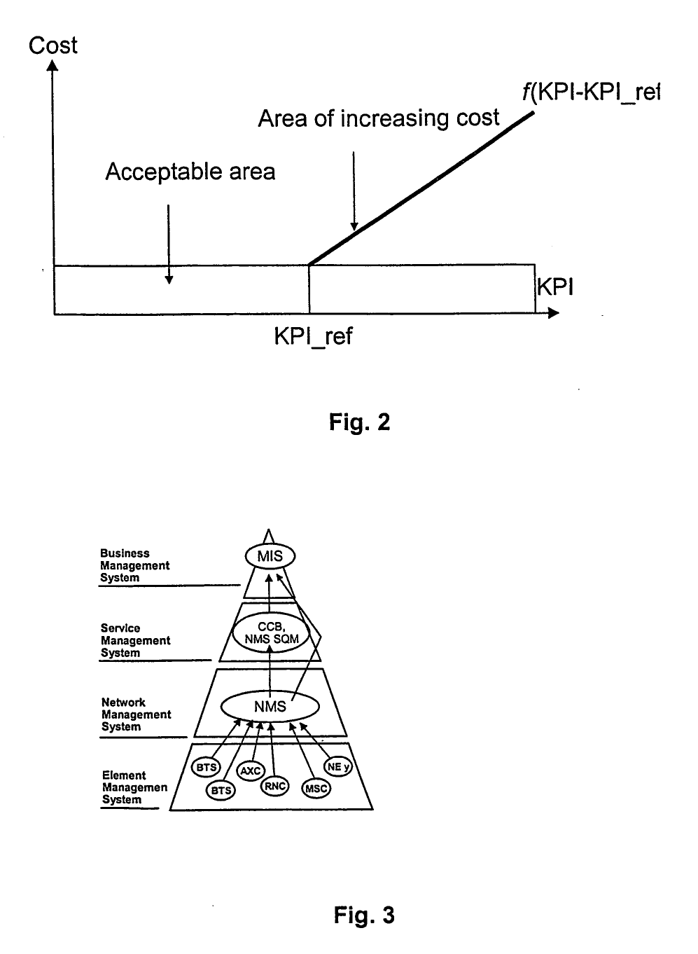

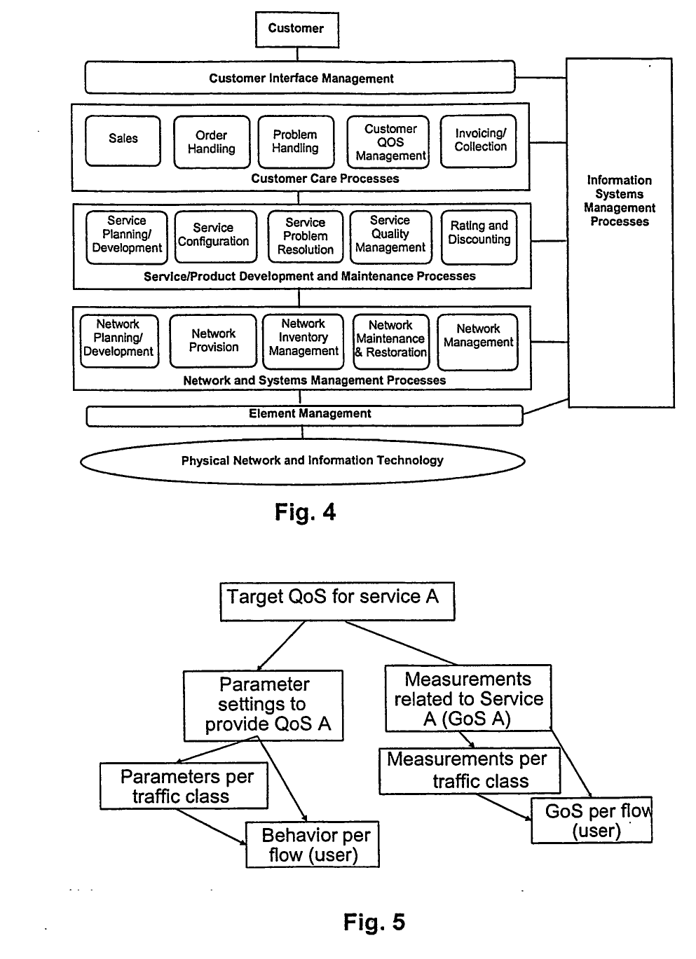

FIG. 2 shows an example of a KPI cost function f. In this example, the cost for KPI values higher than KPI_ref is increasing linearly. However, the cost functions can also take other shapes.

The total cost function to be optimised, i.e. minimized, is presented in equation (3). A trade-off between capacity and quality requirements can be accomplished using the parameter W. The minimization is performed by adjusting the configuration parameters (2). The KPI values also depend on the service distribution, e.g. different costs and parameter settings will be achieved depending on the service distribution.

KPI_{—}Cᵢ=f(Configuration parameters, Service Distribution)

KPI_{—}Qⱼ=f(Configuration parameters, Service Distribution) (2)

Total COST=W*QualityCost+(1−W)*CapacityCost (3)

Factors that may affect the optimisation process are for example the traffic profile (service mix), traffic density, pricing of each service etc. The ultimate goals when minimizing the total cost include to optimise the operators revenue, to minimise CAPEX and OPEX, as well as to maintain good reputation of the operator.

A specific example of the cost function TOTAL COST can be calculated according to equations (4) to (8) as follows:

TOTAL COST=C(Queuing Ratio)+C(BAD Quality Ratio)+C(Dropping Ratio)+C(Blocking Ratio) (4)

with

C(Queuing Ratio)=0.05*Dev(Queuing Ratio−allowed Queuing Ratio) (5)

C(Bad Quality Ratio)=0.2*Dev(Bad Quality Ratio−allowed Bad Quality Ratio) (6)

C(Dropping Ratio)=*Dev(Dropping Ratio−allowed Dropping Ratio) (7)

C(Blocking Ratio)=0.10*Dev(Blocking Ratio−allowed Blocking Ratio) (8)

The optimisation challenge is to combine seamlessly all the different TOM management layers, wherein the fact, that the measurements (quality and cost indicators) from different layers use different language, should be taken into account.

When the optimising process is implemented in the NMS of a network, the operators' decision on the customer care and service management layers are supported. To be able to do this a derivation of cost functions including configuration and (PM) measurements performed on the lower layer are translated to “language” on the layer above. This can be carried out by:

Performing a technical translation (mapping) from Radio Access Network parameter (settings) to service related quality expectations/targets. In practise this means correlating the configuration management and performance management. I.e. certain configured functional entity is monitored by certain set of measurements. The performance of the entity is derived with a cost function utilising the defined measurements.

In practise the following means translation of measurements of larger entity (i.e. cell, traffic class, etc.) to user level entity be able to statistically conclude the quality of individual users. Also this step is performed with a with weighted cost function(s). Furthermore, it is possible to combine these individual translations with cost function to achieve wanted end user quality indication.

1) A technical translation (mapping) from Radio Access Network measurements (network performance) to end user flow level grade of service (experienced quality).

2) A technical translation from aggregate level (UMTS traffic classes) parameters settings to end user flow level grade of service (experienced quality),

3) A technical mapping from measurements per traffic class to settings to end user flow level grade of service (experienced quality),

and/or a combination function of traffic class and flow level information (parameters and settings) with a cost function to support the parameterising and monitoring of end user GOS.

FIG. 5 shows an illustration of the combination of network monitoring and optimising functions which are used to combine different management layers within the network by mapping.

The mapping is carried out from one layer to the next one by combining the network measurements, the performance indicators PI and/or the KPI with a cost function

And cost function for the grade of service GOS as experienced by the subscriber can be calculated as described in equation (9):

GOS=C(Service Availability)+C(Delay and Jittering)+C(Quality)+C(Dropping)+C(Service Accessibility)+C(Equivalent Bitrate or User throughput) (9)

Wherein the delay is composed of Service Access Delay and Queuing Transmission Delay. Non real-time quality is influenced by packet loss, Radio Link Control RLC, Packet Data Convergence Protocol PDCP, i.e. by the bit error rate BER and the block error rate BLER. Regarding the realtime quality the quality is bad if uplink UL block error rate BLER is significantly higher than the target BLER. The real-time quality is influenced by the downlink DL connection power outage. The input of the above cost function comprises capacity requests and traffic distribution. The measurements of the total throughput is carried out in kbps/cell/MHz.

The spectral efficiency of the cost function equals to the throughput in kbps/cell/MHz when 98% of the users are satisfied. This means that the service accessibility and the blocking probability is 2%. The equivalent bitrate is greater than 10% of the bearer service data rate and 98% of a users are not dropped. The motivation behind this approach is to metrically assess the benefits of the optimisation in terms of GOS.

This mapping has to be done for all services which are provided, i.e. services which are controlled with different parameter settings or other attributes.

Although, each translation is causing degradation in accuracy, the mapping is statistically correct. Due to the fact that the operation is carried out in statistical level the best location for the mapping functions is NMS. Furthermore, NMS implementation is also able to handle the Radio Network Controller RNC-RNC (or other network element) border areas. In each of these translations the proposed cost function method is applied. In some of the cases the service QoS targets can cause conflict in the parameter settings, therefore a cost function is needed to solve the conflict. This can be carried out by providing different weight coefficients for the different elements in the cost function. This idea will gain importance when different customer classes (silver, bronze, gold. etc) are introduced into the network system.

Furthermore, the next major step when changing to the last management layer of TOM model is to perform the evaluation of the network optimisation, service prioritising as well as customer differentiation operation in terms of ε, $ or £. At this stage the billing and charging information from the Invoicing/Collecting subsystem in the customer care layer of the TOM is needed. When utilizing the knowledge of the customer base/profiles and behaviour of those profiles it is possible—on the basis of a cost function—to optimise the business case of the operator to the direction that is the most beneficial. It is worth noting that changing the customer priorities and offered QoS for business reasons will cause change in the customer behaviour and the business management level optimisation is thus iterative.

To guarantee the optimum performance of a cellular network, it is preferable for the operator to have flexible means to set the QoS target based on the system KPIs (key performance indicator) and/or a cost function derived from those. The QoS targets may either be set for a cell cluster or per cell basis. The QoS can be evaluated in terms of blocked calls due to hardware resources, “soft” blocked calls (in interference limited networks), dropped calls, bad quality calls, number of retransmissions and delay in case of packed data, diversity handover probability, hard handover success rate, loading situation (uplink UL or downlink DL), ratio of packed data to circuit switched services etc.

In multi-radio environments (GSM-WCDMA Global System for Mobile Communications—Wideband Code Division Multiple access) it is important to have the possibility to pool the resources of both of the networks for optimised capacity, coverage and quality. This requires an over all control functionality (quality manager) on higher (KPI) level, i.e. the optimising process according to the invention can be implemented as the quality manager.

The quality manager QM, i.e. the optimising process, provides a central monitoring function and monitors the status of the parameter values and identify automatically the problem situation by comparing the history information of the parameter values as stored in the history database. E.g. GERAN and UMTS Terrestrial Radio Access Network UTRAN can be split into auto-tuning subsystems as small and independent as possible. Interdependencies between subsystems are taken into account in upper layers of quality manager, by providing weight coefficients for the KPI's of their respective subsystems.

In another embodiment, the optimising process is carried out on the basis of user groups (like business users, free time uses etc.).

Summarising it can be said that, currently for all the parameter values default value are proposed. Up till now was the operator's task to optimise the network cell by cell (trying to take the multi-cell environment into account). However, by using the method and/or the system for optimising the network performance according to the invention the initial parameter setting could be made less important. For example in the beginning of the network operation the admission control and handover control could work with very “loose” limits admitting all the users to the network, based on the current QoS situation (KPIs at the operating service system OSS) and the set QoS targets the relevant parameters can be auto-tuned. After the parameter change the new situation, i.e. the new KPI values, is compared to the KPI history data and the “test” parameters are accepted if the change in the QoS performance (or the cost function of the QoS requirements) is improved. The length of the history data depends on the amount of the traffic in the network (total number of samples should be high enough). It is important that the QoS cost function contains items from the whole RRM and multi-radio area.

The key parameters (in terms of optimum capacity and quality) are currently initially set to a “default” value, which in most cases guarantees operation of the network but not the optimum performance. The optimising process according to the invention automatically changes the settings for the essential parameters to the optimum operating point in terms of overall QoS.

The adjustments of the configuration parameters can be constant increments or decrements. Alternatively, the increments or decrements can be made variable.

According to a third embodiment of the present invention a cost function is used to optimize network resources centrally and provide a desired level of quality of service (QoS). The cost C is a function of different KPI's of the network, for example

$$C = {\sum }_{i = 1}^{N} {F}_{i} ( {KPI}_{i} ) \qquad ( 11 )$$

where KPIᵢ is the i-th key performance indicator and Fi is some positive function which can be used to transform, weight and/or scale the i-th KPI. The network performance is optimized by minimizing this cost function C. The minimum of the cost is achieved by a proper choice of different network parameters W=(w₁; w₂; . . . , w_{N}) which would be considered the optimum value of the parameters. The cost function approach, implicitly assumes that the value of the KPI's are functions of the network parameters, that is,

KPIⱼ=KPIⱼ(w₁; w₂; . . . , w_{N}) ∀j (12)

and hence the cost function C is also a function of the network parameters, and can be rewritten as direct function of the parameters as,

$$C = {\sum }_{i = 1}^{N} {g}_{i} ( {w}_{i} , t ) \qquad ( 13 )$$

where the gᵢ are some functions which may vary with time t.

The third embodiment particularly relates to a simple but efficient algorithm to minimise the above cost function. However, the optimisation of such a cost function is not straightforward in a real situation. The main problems can be listed as follows:

1. In a real network there is much variation in traffic types, user distributions and load. These factors are not controllable by the network and can be considered as random external noise sources. Any optimisation algorithm should be insensitive to such external random influences.

2. Because of the variations in the load etc. at different times, the optimum choice of parameters for any given network can evolve over time (i.e. the functions gᵢ of equation (13) vary with time). Any optimisation algorithm should be able to adapt to such variations in the optimum operating point of a network and be able to track these changes.

3. Generating a model of the network which can be used for optimisation in every different situation may not be feasible. This means that the functions gᵢ of equation (13) are not known. The alternative, and the approach taken in the third embodiment, is not to assume any model for the network but to base the optimisation uniquely on network measurements.

The optimisation algorithm to be used in the minimization of the cost function is described and derived from first principles. Consider the general case of a cost function C to be minimized with respect to a parameter denoted w. Let w₀ be the value of w which minimizes C. Evaluating C(w₀) using the Taylor series expansion about any value of w gives,

$$C ( {w}_{0} ) = C ( w ) + ( {w}_{0} - w ) * {C}^{′} ( w ) + \frac{{( {w}_{0} - w )}^{2}}{2} {C}^{′′} ( w ) \qquad ( 14 )$$

where C′(w) is the first order differential of C with respect to w and C″(w) the second order differential. As C(w₀) is a minimum point of C then differentiating equation (14) with respect to w₀ and letting the result equal 0, gives,

$${w}_{0} = w - \frac{{C}^{′} ( w )}{{C}^{′′} ( w )} \qquad ( 15 )$$

which is a classic Gauss-Newton algorithm optimisation algorithm with a rapid convergence. In the case where C is a quadratic function of w, then there is a one step convergence to the optimum point w₀. In the case where C is not quadratic then convergence is guaranteed so long as C″(w) is always positive. In the case where it is not then it can be made positive and equation (15) resolves to a standard gradient algorithm. However as the minimum point of C is approached then the quadratic approximation becomes more accurate and the convergence speed is high.

The problem is now considered in terms of the WCDMA cost function. As mentioned above, since we do not have a model of the network, it is difficult to find a value for C′(w) and C″(w) hence equation (15) is difficult to use. Nevertheless according to the third embodiment the values of C′(w) and C″(w) are evaluated from network measurements allowing the use of equation (15).

Consider a small change δw>0 in the value of the parameter w to give a new parameter value w+δw. The value of the cost function can then be approximated as,

$$C ( w + δ w ) = C ( w ) + δ w * {C}^{′} ( w ) + \frac{δ {w}^{2}}{2} {C}^{′′} ( w ) \qquad ( 16 )$$

similarly an expression for C(w−δw) can be derived as

$$C ( w - δ w ) = C ( w ) - δ w * {C}^{′} ( w ) + \frac{δ {w}^{2}}{2} {C}^{′′} ( w ) \qquad ( 17 )$$

Adding these two expressions and rearranging the terms results in the expression for C′(wadd) and subtracting the two terms and rearranging the expression leads to the expression for C′(wadd).

$$\begin{matrix}{C}^{′} ( w ) = \frac{C ( w + δ w ) - C ( w - δ w )}{2 * δ w} & ( 18 ) \\ {C}^{′′} ( w ) = \frac{C ( w + δ w ) + C ( w - δ w ) - 2 C ( w )}{δ {w}^{2}} & ( 19 )\end{matrix}$$

Hence it is possible to derive values or approximations to the values of C′(w) and C″(w) from equations (18), (19) by knowing the values of C(w+δw) and C(w−δw). The next question is how to evaluate these values at any particular time. This is performed according to the following steps:

1. At time t1 the parameter value is w and the value of the cost function C(w; t1) is evaluated from equation (11) based on network measurements of the appropriate KPI's at time t1.

2. At time t1 the value of w is changed to w+δw.

3. At time t2=t1+δt; δt>0, the value of the cost function is evaluated from equation (11) based on network measurements of the appropriate KPI's to give C(w+δw; t2).

4. At time t2 the parameter w is changed to w−δw.

5. At time t3=t2+δt the cost function is evaluated from equation (11) based on network measurements of the appropriate KPI's to give C(w−δw; t3).

6. At time t3 a new value of w is calculated using equation (15) with C′(w) and C″(w) respectively given by equations (18), (19) and the values of C(w), C(w+δw) and C(w−δw) given respectively by the measurements C(t1); C(t2); C(t3).

These steps constitute one cycle of the algorithm and the cycle can be repeated over. Consider now the point discussed above concerning the noise fluctuations which would appear in the different network measurements. Although this algorithm is derived for a cost function with no noise term it can also be applied to a noisy cost function.

The effect of repeating the above algorithm is to average out the noise effects and the parameter converges to an average value. This type of algorithm has been well studied in the area of stochastic optimisation for example in Kushner, H. J. and Clark, D. S. (1978), Stochastic Approximation Methods for Constrained and Unconstrained Systems, volume 26 of Applied Mathematical Sciences, Springer-Verlag, New York, Heidelberg, Berlin. The averaging out of the noise effects is also helped by allowing w to both increase and decrease over time. Also in a real network the noise effects will be reduced as normally the measurements are integrated over the δt time period. The value of δt can be chosen appropriate for the parameter being optimised and may change during the optimisation process.

Furthermore it is evident how this algorithm can track changes in the optimum point of the network. Even when the parameter has reached an optimum point, the algorithm causes small fluctuations about this point. As long as the optimum point does not change then the fluctuations will average out to zero around the optimum point. If the optimum point changes then the algorithm can still track this change.

While in the first embodiment the value of a configuration parameter for the KPI's is adjusted, the cost function is recalculated, compared with the cost function based on the previous value of the configuration parameter and the newly adjusted value is adopted as new configuration parameter, according to the second embodiment the value of the configuration parameter is adjusted in two steps. First the value of the configuration parameter is increased and the cost function is re-calculated on the basis of the new value and the result is compared with previous results of the cost function. Then the value of the configuration parameter is decreased and the cost function is re-calculated on the basis of the new value and the result is compared with previous results of the cost function. However even if the results of the cost function of the two previous changes do not improve, a small or zero change of the configuration parameter is preformed.

Alternatively, in a fourth embodiment based on the third embodiment, the cost function and its optimisation is described with regards to one specific network parameter, i.e. the specific problem of deriving and optimising a cost function based on the Key Performance Indicator (KPI), the Blocked Call Ratio (BKCR), is now discussed.

The WCDMA radio interface for third generation mobile networks can carry voice and data services with various data rates, traffic requirements, and quality-of-service targets. Moreover, the operating environments vary greatly from indoor cells to large macrocells. Efficient use of limited frequency band in the diverse conditions requires careful setting of numerous vital network and cell parameters. The parameter setting is referred to as radio network planning and optimisation. Once a WCDMA network is built and launched, its operation and maintenance is largely monitoring of performance or quality characteristics and changing parameter values in order to improve performance. The automated parameter control mechanism can be simple but it requires an objectively defined performance indicator, or in this case a cost function, that unambiguously tells whether performance is improving or deteriorating.

The goal of the optimisation is to minimize the total level of blocked calls in the network. The specific parameter to be optimised is the soft handover parameter window add (wadd). Gains in performance based on soft handover have been studied in “Soft handover gains in a fast power controlled WCDMA uplink” Sipila, K.; Jasberg, M.; Laiho-Steffens, J.; Wacker, A. Vehicular Technology Conference, 1999 IEEE 49th , Volume: 2 , 1999 Page(s):1594-1598,vol.2.. It has been found that considerable care should be taken when defining the cost function to be Minimized. Combining the terms in the wrong manner could lead to a cost function, which remains constant for any choice of parameters.

Some factors that affect the performance of the network cannot be controlled directly by adjusting the network parameters. For example the number of users, user distribution and the type of traffic. Changes in these external parameters result in fluctuations of the cost function. This means any optimisation algorithm used to minimize the cost function should be robust and lead to a convergence even in the presence of random fluctuations. Such algorithms have been well studied in the area of stochastic approximation Kushner and Clark, “Stochastic Approximation Methods for Constrained and Unconstrained Systems, Springer-Verlag, New York, Heidelberg, 1978. The relevant result from these studies to the cost function optimisation problem here is that even in a noisy environment the optimisation problem can be treated as a noise free optimisation when applied repeatedly averages out the noise fluctuations in the system. This approach is used here and an optimisation algorithm is derived to optimize a deterministic cost function and in practice is applied to minimize a noisy cost function.

A second consideration in choosing an optimisation algorithm for the cost function is that the optimum operating point of the cost function may change. Hence the optimisation algorithm should be able to track any changes in the state of the cost function. It will be shown by analysis that the proposed algorithm can have a quadratic convergence to a minimum of the cost function as compared to the linear convergence of a standard gradient algorithm.

A quality manager is a logical unit in the radio network controller that collects statistics of various performance indicators. The quality manager calculates these statistics over a specified interval of time, which will be called qmlnterval. Some of the statistics made available by the quality manager include:

At every qmlnterval, interval, the quality manager goes through all connections of the sector and checks the call quality. The number of bad quality calls and the total number of calls are accumulated in two counters over the control period. The quality is obtained as the ratio of the counter values.

The ratio of the blocked calls to the total number of admission requests during the previous qmlnterval.

The ratio of calls ended by dropping to the total number of ended calls during the previous qmlnterval.

Here only the blocking ratio was used, however the methods and simulations could be extended to include the other statistics returned by the quality manager.

Consider the general case of a cost function C (cf. equation 11) to be minimized with respect to the handover parameter, window add denoted wadd. Let wadd₀ be the value of window add which minimizes C. Evaluating C(wadd₀) using the Taylor series expansion about wadd gives,

$$C ( {wadd}_{0} ) = C ( wadd ) + ( {wadd}_{0} - wadd ) * {C}^{′} ( wadd ) + \\ \frac{{( {wadd}_{0} - wadd )}^{2}}{2} {C}^{′′} ( wadd ) \qquad ( 20 )$$

where C″ is the first order differential of C with respect to wadd and C″ the second order differential. As C(wadd₀) is a minimum then differentiating equation (1) with respect to wadd₀ and letting the result equal 0, gives,

$${wadd}_{0} = wadd - \frac{{C}^{′} ( wadd )}{{C}^{′′} ( wadd )} \qquad ( 21 )$$

which is a classic Gauss-Newton algorithm, with a rapid convergence. The values of C′ and C″ must be known at wadd. It is now shown how these values can be estimated from the network. Please note that equation (20) and (21) correspond to equations (14) and (15) relating the more general form of said equations.

Consider a change of window add by δwadd to wadd+δwadd and the corresponding value of the cost function C(wadd+δwadd). Similarly consider a change of window add to wadd−δwadd and the corresponding value C(wadd−δwadd) of the cost function, then it is possible to show by some algebraic manipulation that C′(wadd) and C′(wadd) can be given as,

$${C}^{′} ( wadd ) = \frac{\begin{matrix}C ( wadd + δ wadd ) - \\ C ( wadd - δ wadd )\end{matrix}}{2 * δ wadd} \\ {C}^{″} ( wadd ) = \frac{\begin{matrix}C ( wadd + δ wadd ) + \\ C ( wadd - δ wadd ) - 2 * C ( wadd )\end{matrix}}{ {wadd}^{2}} \qquad ( 22 )$$

if C is quadratic and hence there is one step convergence. If C is not quadratic then the expressions in equation (22) are an approximation, but there is still a rapid convergence compared to a standard gradient algorithm. Closer to wadd₀ the approximation to quadratic becomes more accurate. In the real case the algorithm is implemented as follows:

1) At time t1 the value of window add is wadd, and the value of the cost function C(t1) can be evaluated from network measurements. At time t1, the value of wadd is changed to wadd+δwadd.

2) At time t2(>t1), the value of window add is wadd+δwadd, the cost function value C(t2) can be evaluated directly from network measurements. At time t2 the value of window add is changed to wadd−δwadd.

3) At time t3(>t2), the value of window add is wadd−δwadd, the cost function value C(t3) can be evaluated directly from network measurements. At time t3, the value of wadd is updated using equation (20), and equations (21), (22) with

C(wadd)=C(t1)

C(wadd+δwadd)=C(t2)

C(wadd−δwadd)=C(t3) (23)

This process is repeated over, leading to a minimization of the cost function. A point worth noting is that two goals are achieved by alternately increasing and decreasing the value of window add. The first being as described above, is to estimate C′ and C″. The second goal is more implicit. Consider the case where the algorithm has converged to the minimum of the cost function. At this point the gradient of the function is zero and the optimisation is over. However over time the optimum point of the network and hence the cost function may change. By alternating the value of wadd as described above, any such changes can be detected and followed by the algorithm.

The next stage in this fourth embodiment is to develop a cost function that can be minimized using the optimisation algorithm as described above. In the first most general case the cost function can be described by equation (11) where KPIᵢ is the iₜₕ KPI of the network and Fᵢ is some function to be defined. Each term of the cost function should be always positive and hence the cost function will always be positive. Also the function Fᵢ should scale KPIᵢ such that in normal operation this term does not dominate the cost function. For example for a value of KPIᵢ operating in a desired range which would ensure the correct quality of service then Fᵢ(KPIᵢ) should be in the range [0, 1].

In the fourth embodiment we are interested only in the blocking rate. The aim is to minimize the blocked call ratio (BKCR) as a function of window add. BKCR is very dependent on the value of window add. In this case the most obvious cost function to minimize would be a simple sum of the blocking ratios. However for several reasons a better choice of cost function in this case is

C=ulBKCR²+dlBKCR² (24)

where ulBKCR is the uplink blocked call ratio and dlBKCR is the downlink blocked call ratio. However in any real network for an acceptable level of service the blocked call ratio must be less than a certain value, for example 5%. The cost function can be further modified to “punish” values of blocking significantly higher than this value. For example,

C=f(ulBKCR)²+f(dlBKCR)² (25)

where,

f(x)=exp(x*12)−1 (26)

The choice of this function means that for a value of 5% uplink blocking the value of f(ulBKCR)=1.0. For values less than 5% the function is almost linear. However for values greater than 5% the function increases exponentially. The usefulness of the function f is more obvious when there are more terms in the cost function. Another important characteristic of the function f is that it is continuously differentiable function and hence there is no problem when deriving the derivatives of the cost function used in the optimisation algorithm.

In a fifth embodiment the algorithm according to the third embodiment can be extended to minimizing a cost function when several network parameters are to be optimised. The multiple parameter case is performed by reducing it to the one parameter problem of the third embodiment. Consider the vector W of N parameters wᵢ to be optimised,

W=(w₁; w₂, . . . ; wₙ) (27)

Consider an initial value of these parameters from which the optimisation is to begin. This initial value may be randomly chosen as,

Wₒ=(w₀;₁; w₀;₂; . . . ; w₀;_{N}) (28)

Define a line in the N dimensional parameter space which contains this initial point W₀ as

L₀=W₀+λ\overline{n}₀ (29)

The N dimensional vector \overline{n}₀ is a unit vector which initially once again has arbitrary direction and the factor λ is a scalar variable. The idea is to minimize the cost function along the line L₀. This corresponds to finding the optimum value of λ, which is a scalar value, and hence the algorithm described in the previous section can be used. Assuming that the optimum value is λ₀ and hence the new value of W is given by,

W₁=W₀+λ₀\overline{n}₀ (30)

Define another line L₁ as

L₁=W₁+λ\overline{n}₁ (31)

where now \overline{n}₁ is a conjugate direction to \overline{n}₀. The optimisation of the cost function is repeated along this newly defined line once again using the algorithm of the third embodiment. In theory in a noiseless system the optimisation along a line would have to be repeated N times along N conjugate directions (\overline{n}₀, \overline{n}₁, . . . , \overline{n}_{N-1}). In the case of a noisy cost function more cycles would have to be repeated to cancel out noise effects. There are many well known methods to generate the conjugate directions at each step of the optimisation. A better minimization of the cost function can be achieved by simultaneously optimising several network parameters as compared to optimising them separately.

A further advantage of using this type of algorithm, especially when it is extended to higher dimensions is that by causing small fluctuations in the parameters, it may be possible to escape from local minima of the cost function.

The optimising method according to the first, second, third or fourth embodiment may be based not only on the last two results of the cost function but also on a previous history of measurements of the cost function. Accordingly, at a time t, the change effected to the parameters may be a function of the cost function and the respective parameter values at different times t, t-1, t-2, t-3, . . . , t-n. Therefore, the parameters can be updated or adopted as a function of the previous measurements.

1. A method for optimising the performance of a network, in particular a radio network performance, comprising the steps of:
determining relevant key performance indicators for an entity within the network and first parameters, upon which said key performance indicators depend on,
selecting a number of similar entities,
calculating a first cost function on the basis of the determined key performance indicators and the selected number of entities, in order to evaluate the network performance on the basis of first values of said first parameters, wherein said first values of said first parameters represent the current values of said first parameters,
adjusting the values of said first parameters resulting in second values of said first parameters,
re-calculating said first cost function on the basis of the key performance indicators as determined according to said second values of said first parameters to evaluate the network performance,
comparing the result of said first cost function according to said first values of said first parameters with the result of said first cost function according to said second values of said first parameters to determine whether the network performance has improved,
adopt said second values of said first parameters as permanent parameters if the network performance on the basis of said second values of said first parameters has improved.

2. A method according to claim 1,
wherein the respective determined key performance indicators are weighted with different weight coefficients within said first cost function.

3. A method according to claim 1,
wherein reference values for the key performance indicators are set, and the difference between the current key performance indicators and the respective reference values thereof are determined and are used as elements in said first cost function.

4. A method according to claim 1,
wherein said first cost function is composed of a second cost function representing the quality requirements within the network and a third cost function representing the capacity requirements within the network, wherein said second cost function is weighted with a second weight coefficient and said third cost function is weighted with a third weight coefficient.

5. A method according to claim 4,
wherein said third weight coefficient equals to said second weight coefficient subtracted from one.

6. A method according to any claim 1,
wherein said second and third cost functions comprise the determined key performance indicators for each selected entity as elements.

7. A method according any to claim 1,
wherein said entity within the network is represented by a cell or a user group within said network.

8. A method according to claim 1,
wherein the steps for optimising the network performance are iterated.

9. A method according to claim 1, comprising the step of:
storing the values of the key performance indicators together with the respective first parameters and the corresponding result of the first cost function in order to create a history database.

10. A method according to claim 1, wherein the comparing step includes the steps of:
comparing the results of said first cost function with stored previous results of the first cost function in said history database in order to determine whether the network performance has improved within the predetermined time interval, and
notifying if no improvements of the network performance has been made in said predetermined time interval.

11. A method according to claim 8, wherein
said step of adjusting the values of said first parameter is performed by increasing and decreasing said values alternately.

12. A method according to claim 11, wherein
said steps of increasing and decreasing said values of said first parameters are performed successively before performing said adopting step.

13. A method according to claim 1,
wherein quality of service indications for services and/or individual subscribers are derived from measurements and/or configurations of low management layers within the network.

14. A system for optimising the performance of a network, in particular a radio network performance, comprising:
a) means for determining a relevant key performance indicator for an entity within said network and a first parameter, upon which said key performance indicator depends on,
b) means for selecting at least one similar entity,
c) means for calculating a first cost function on the basis of said determined key performance indicator and said selected at least one entity, in order to evaluate the network performance on the basis of a first value of said first parameter, wherein said first value of said first parameter represents a current value of said first parameter,
d) means for adjusting said first value of said first parameter to obtain a second value of said first parameter,
e) means for re-calculating said first cost function on the basis of said relevant key performance indicator determined according to said second value of said first parameter to evaluate the network performance,
f) means for comparing the result of said first cost function according to said first value of said first parameter with the result of said first cost function according to said second value of said first parameter to determine whether the network performance has improved, and
g) means for adopting said second value of said first parameter as permanent parameters if the network performance on the basis of said second value of said first parameters has improved.

15. A Computer program product comprising computer program code means for causing a computer to perform the steps of the method as claimed in claim 1 when said computer program is run on a computer.
